(19) United States
(12) Patent Application Publication
(10) Pub. No.: US 2014/0297724 A1
(43) Pub. Date: Oct. 2, 2014

(54) NETWORK ELEMENT MONITORING SYSTEM AND SERVER

(71) Applicant: FUJITSU LIMITED, Kawasaki-shi (JP)

(72) Inventor: Akinori Matsuno, Kahoku (JP)

(73) Assignee: FUJITSU LIMITED, Kawasaki-shi (JP)

(21) Appl. No.: 14/152,013

(22) Filed: Jan. 10, 2014

(30) Foreign Application Priority Data
Mar. 29, 2013 (JP) 2013-073785

(51) Int. Cl. H04L 12/26

(52) U.S. Cl. CPC H04L 43/08
USPC 709/203; 709/224

(57) ABSTRACT

A first server changes an execution source of health check to a second server in response to a reception state of event information from an NE of a monitoring target.

### CROSS-REFERENCE TO RELATED APPLICATIONS

This application is based upon and claims the benefit of priority of the prior Japanese Patent Application No. 2013-073785, filed on Mar. 29, 2013, the entire contents of which are incorporated herein by reference.

### FIELD

The embodiments discussed herein are directed to a network element monitoring system and a server.

### BACKGROUND

An aspect of a transmission apparatus operating system is a client-server type system which is configured with a client system including one or more client apparatuses and a server system which is redundantly configured in order to improve reliability and robustness of a system as illustrated in FIG. 26.

The server system is communicatively connected to one or more transmission apparatus (network elements (NEs)) via a network (hereinafter, referred to as a “monitoring network”), and monitors an operation state of the NE. Further, the server system is communicatively connected to the client system, and is available to provide the client system with the NE monitoring result.

In order to improve a monitoring performance, there are cases in which the server system employs a hot standby type redundant configuration in order to monitor (hereinafter, dual-monitor) a transmission apparatus from both servers of active and standby (ACT and STBY) systems.

In order to implement dual monitoring, both servers of ACT and STBY systems independently perform check (e.g. health check) of an operation state (or communication state) on an NE of a monitoring target. Further, when a failure occurs in an NE or a state change occurs in an NE, each server is available to receive a trap transmitted from a corresponding NE and manage the trap.

For management of configuration information (for example, area information, node information, facility information, and path information) of a communication network and an NE, information synchronized between both system servers may be managed using a multi-master type replication.

As one of techniques of monitoring a transmission apparatus, a technique disclosed in JP 2008-219279 A has been known.

Recently, as a communication traffic amount increases and types of communication services are diversified, the number of NEs managed by a single system tends to increase. For this reason, even when an operation is normally performed, a load of a server is increased due to execution of health check or a trap notified from an NE, or a communication load of a monitoring network between a server and an NE increases.

In this situation, as illustrated in FIG. 27, when a large amount of traps occurs due to a failure of an NE which is a monitoring target, a communication load of a monitoring network is further increased. As a result, a trap transmitted from an NE during a normal operation is missed or arrives with a delay, and thus NE monitoring is affected. For example, in the client system, it may be unavailable to check a trap, or a trap may be displayed with a delay from a point in time at which a trap actually occurs.

Furthermore, in order to process a large amount of traps, a processing load of a server increases as well, and the whole NE operating system is affected.

### SUMMARY

An aspect of a network element monitoring system includes a first server and a second server configured to perform health check on a plurality of network elements (NEs) and to monitor operation states of the NEs, and the first server changes an execution source of the health check to the second server in response to a reception state of event information from an NE of a monitoring target.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram schematically illustrating an exemplary transmission apparatus (NE) operating system (NE monitoring system) according to an embodiment;

FIG. 2 is a diagram for describing of an exemplary schematic operation of the system illustrated in FIG. 1;

FIG. 3 is a block diagram illustrating an exemplary hardware configuration of a client apparatus illustrated in FIGS. 1 and 2;

FIG. 4 is a functional block diagram of the client apparatus illustrated in FIGS. 1 and 2;

FIG. 5 is a block diagram illustrating an exemplary hardware configuration of an NE illustrated in FIGS. 1 and 2;

FIG. 6 is a functional block diagram of the NE illustrated in FIGS. 1 and 2;

FIG. 7 is a block diagram illustrating an exemplary hardware configuration of a server system illustrated in FIGS. 1 and 2;

FIG. 8 is a functional block diagram of a server illustrated in FIGS. 1 and 2;

FIG. 9 is a diagram illustrating an exemplary configuration information database illustrated in FIG. 8;

FIG. 10 is a diagram illustrating an exemplary notification information database illustrated in FIG. 8;

FIG. 11 is a flowchart illustrating an exemplary operation of a health check management unit illustrated in FIG. 8;

FIG. 12 is a flowchart illustrating an exemplary operation of a notification information management unit illustrated in FIG. 8;

FIG. 13 is a flowchart illustrating an exemplary operation of the notification information management unit illustrated in FIG. 8;

FIG. 14 is a flowchart illustrating an exemplary operation of the notification information management unit illustrated in FIG. 8;

FIG. 15 is a flowchart illustrating an exemplary operation of the health check management unit illustrated in FIG. 8;

FIG. 16 is a flowchart illustrating an exemplary operation of the notification information management unit illustrated in FIG. 8;

FIG. 17 is a flowchart illustrating an exemplary operation of a management unit illustrated in FIG. 8;

FIG. 18 is a flowchart illustrating an exemplary operation of the notification information management unit illustrated in FIG. 8;

FIG. 19 is a flowchart illustrating an exemplary operation of the notification information management unit illustrated in FIG. 8;

FIG. 20 is a flowchart illustrating an exemplary operation of the health check management unit illustrated in FIG. 8;

FIG. 21 is a diagram for describing an exemplary schematic operation of the system illustrated in FIG. 1;

FIG. 22 is a diagram schematically illustrating an exemplary transmission apparatus (NE) operating system (NE monitoring system) according to another embodiment;

FIG. 23 is a flowchart illustrating an exemplary operation of the management unit according to another embodiment;

FIG. 24 is a flowchart illustrating an exemplary operation of the notification information management unit according to another embodiment;

FIG. 25 is a flowchart illustrating an exemplary operation of the notification information management unit according to another embodiment;

FIG. 26 is a diagram schematically illustrating an exemplary transmission apparatus (NE) operating system (NE monitoring system); and

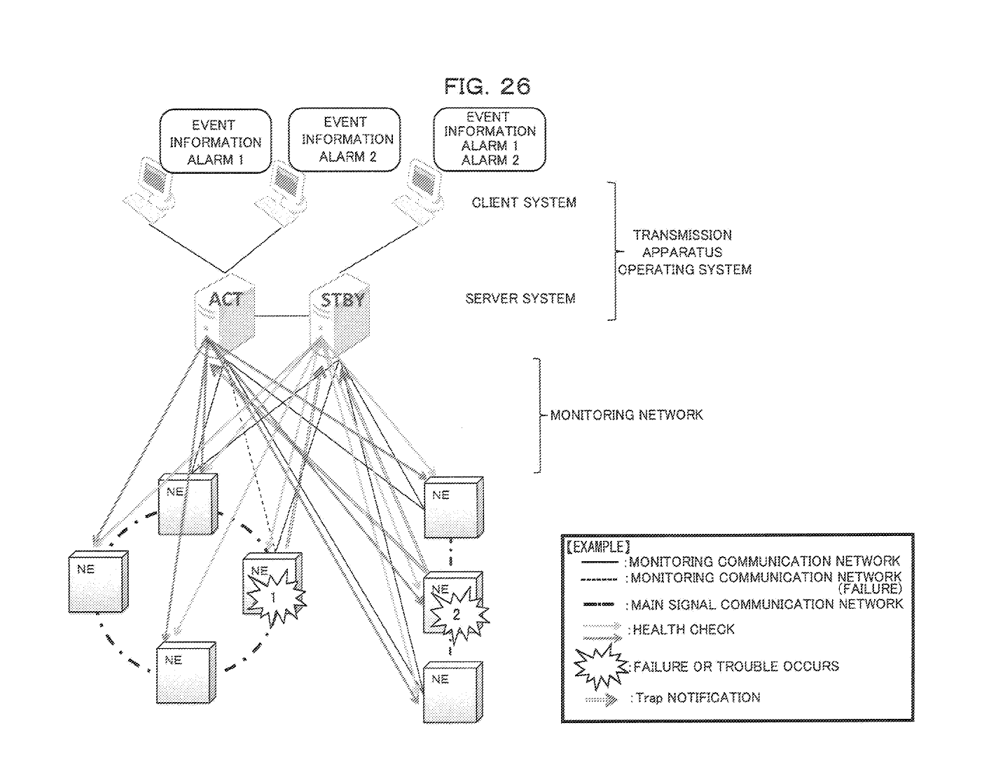

FIG. 27 is a schematic diagram for describing a problem of a system illustrated in FIG. 26.

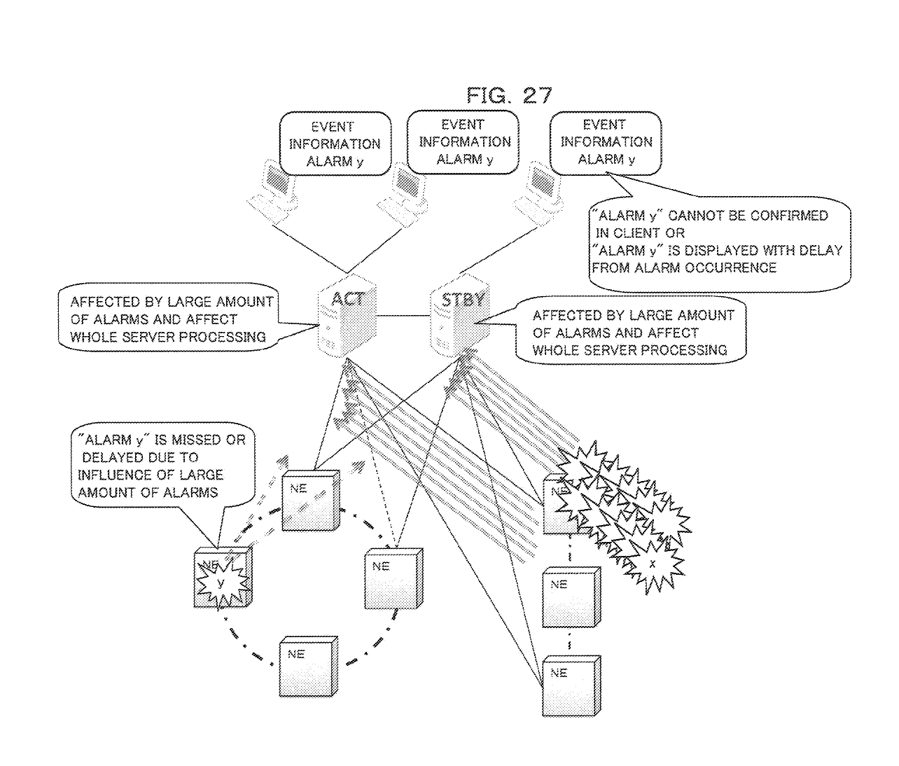

### DESCRIPTION OF EMBODIMENTS

Hereinafter, exemplary embodiments of the present invention will be described with reference to the appended drawings. The following embodiments are merely exemplification and not intended to exclude applications of various changes or techniques which are not described below. In the drawings used in the following embodiments, parts denoted by same references represent same or similar parts unless otherwise set forth therein.

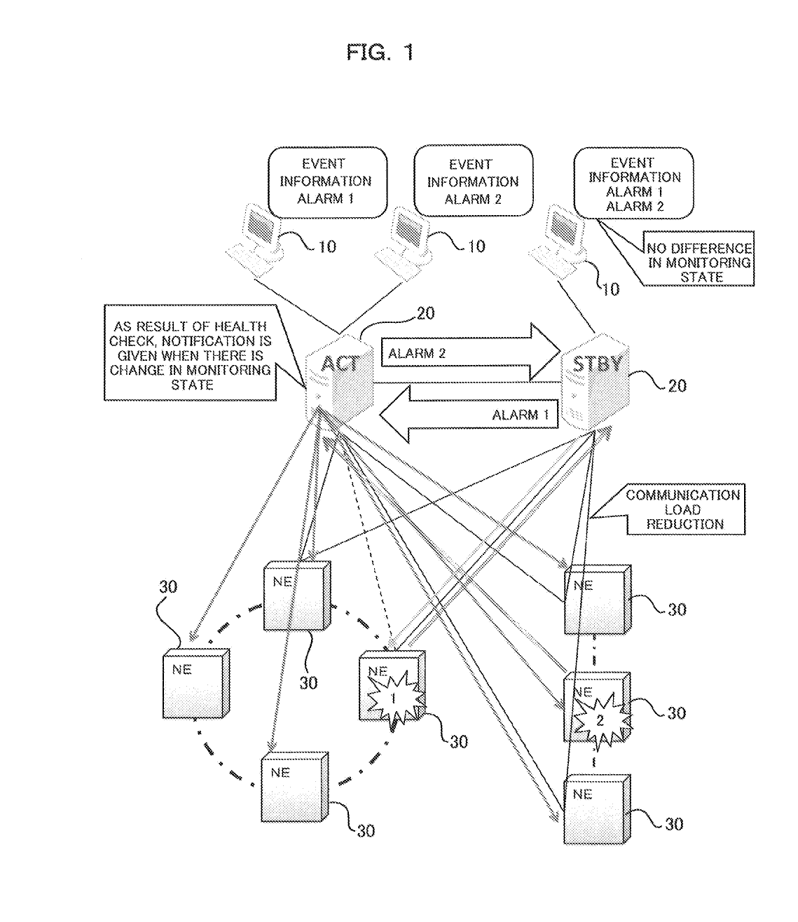

FIG. 1 is a diagram schematically illustrating an exemplary transmission apparatus (NE) operating system (NE monitoring system) according to an embodiment. The transmission apparatus operating system illustrated in FIG. 1 includes a client system including one or more client apparatuses 10, a server system with a redundant configuration including a plurality of servers 20 of ACT and STBY systems, and a plurality of NEs 30 of a monitoring target.

The server system is communicatively connected to any of the NEs 30 via one or more monitoring networks, and monitors the operation state of the NE 30. In the example of FIG. 1, the NE 30 is connected to one monitoring network, and another NE is connected to another monitoring network. The server system receives and manages a trap (hereinafter, also referred to as an “alarm”) transmitted from an NE when a failure, a state change, or the like occurs in the NE 30.

The servers (first and second servers) 20 of the ACT and STBY systems configuring the server system are connected to perform communication with each other. The servers 20 are available to notify each other of information (trap information or the like) held in the respective servers to synchronize the information in the servers. Thus, the client system is available to acquire the same information by accessing any of the servers 20 of the ACT and STBY systems, and no difference in a monitoring state occurs in the client system.

The client system is communicatively connected to the server system and is available to provide an operator or the like with a monitoring result obtained by the server system as event information or the like. The providing may be implemented by displaying the event information on a display (a display device) of a client apparatus or by printing the event information on a printer (a printing device).

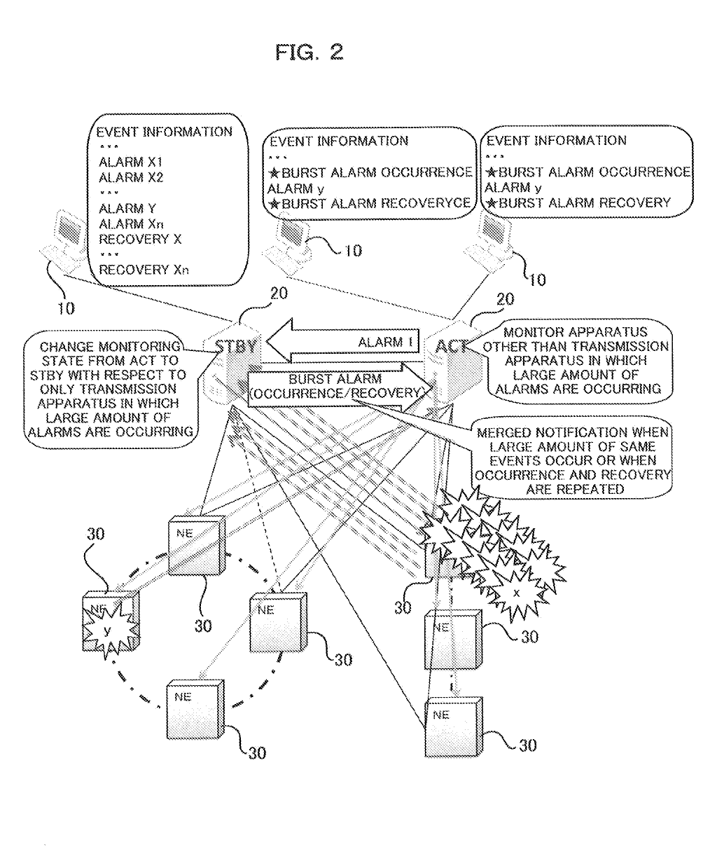

When a large amount of traps (hereinafter, referred to as a “burst alarm”) which are more than a predetermined number (a threshold value) are transmitted to the server 20 of the ACT system within a certain period of time, for example, since some NEs 30 have a failure as schematically illustrated in FIG. 2, the server system switches the corresponding server to the STBY system. At this time, the server system switches the server 20 of the STBY system to the server 20 of the ACT system.

The switching is performed by mutual communication between the servers 20. After the switching, the server 20 of the STBY system sets the NE (hereinafter, referred to as a “burst NE”) 30 that notifies of the burst alarm as a monitoring (health check) target, and the other NEs (hereinafter, referred to as “normal NEs”) 30 which are normally operated are set as a monitoring (health check) target by the server of the switched ACT system. The burst NE 30 is an exemplary first NE, and the normal NE 30 is an exemplary second NE.

Specifically, when the burst alarm is received, the server 20 of the ACT system requests the server 20 of the STBY system to switch to the server 20 of the ACT system and set the NEs 30 other than the burst NE 30 as the monitoring target, and switches itself to the server 20 of the STBY system and sets the burst NE 30 as the monitoring target.

As the server switching is performed, the trap information of the normal NE is transmitted to a switched server 20 of the ACT system. The switched server 20 of the ACT system after the switching may notify the server 20 of the STBY system of the trap information notified from the normal NE 30. Through this operation, information managed by the two servers 20 can be synchronized.

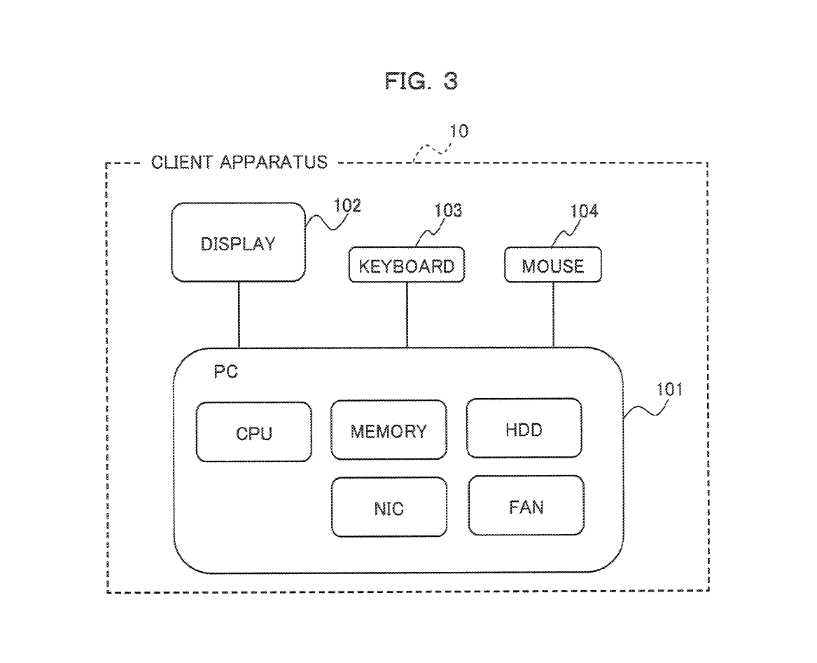

Next, exemplary configurations of the client apparatus 10, the NE 30, and the server system will be described with reference to FIGS. 3 to 8.

(Client Apparatus)

FIG. 3 is a block diagram illustrating an exemplary hardware configuration of the client apparatus 10. For example, the client apparatus 10 illustrated in FIG. 3 includes a personal computer (PC) 101 and peripheral devices such as a display 102, a keyboard 103, and a mouse 104. The display 102 is an example of an output device that provides the operator with information, and the keyboard 103 and the mouse 104 are examples of an input device that inputs information to the PC 101.

For example, the PC 101 includes a CPU, a memory, a hard disk drive (HDD), a network interface card (NIC), a cooling fan (FAN), and the like. As the CPU reads a program or data from the memory or the HDD according to need and performs its operation, the function as the client device 10 is implemented.

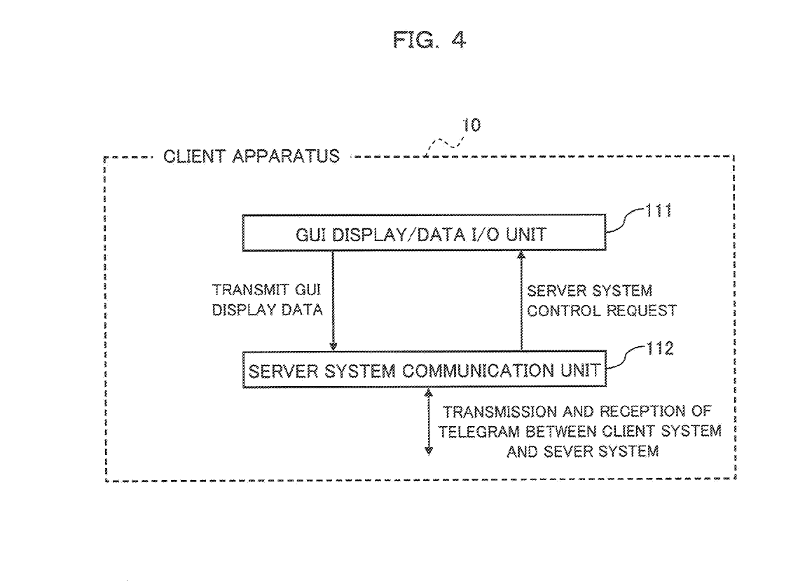

FIG. 4 is a functional block diagram of the client apparatus 10 configuring the client system. For example, the client apparatus 10 illustrated in FIG. 4 includes a graphical user interface (GUI) display/data input/output (IO) unit 111 and a server system communication unit 112.

The GUI display/data IO unit 111 causes information received from the server system communication unit 112 to be displayed on the display 102. The GUI display/data IO unit 111 transmits information received from a user such as the operator to the server system communication unit 112. For example, the information may include a request or the like for controlling the server system.

The server system communication unit 112 transmits information received from the server system to the GUI display/data IO unit 111. Further, the server system communication unit 112 transmits information received from the GUI display/data IO unit 111 through the input device to the server system.

(NE)

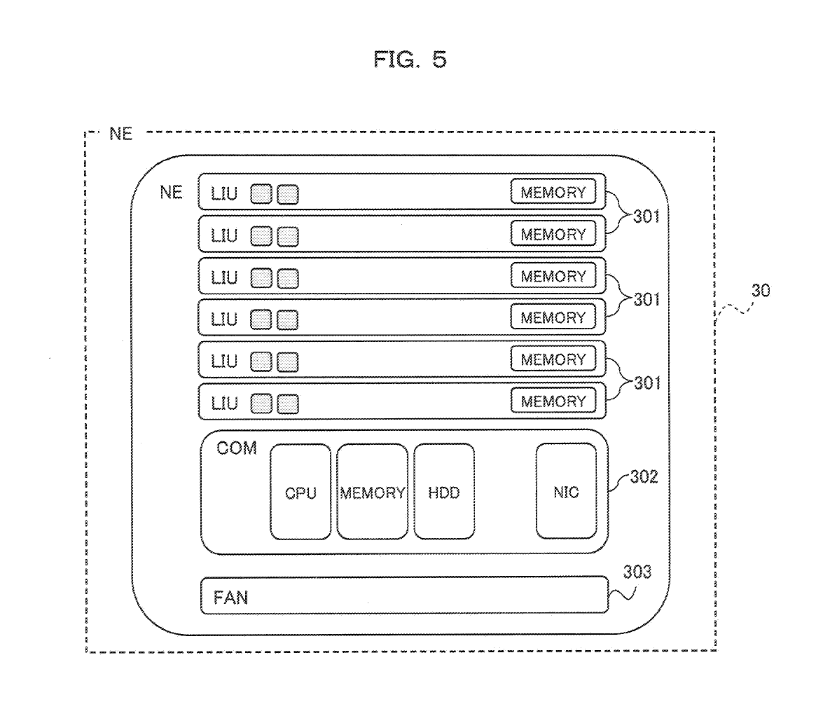

Next, FIG. 5 illustrates an exemplary hardware configuration of the NE 30. For example, the NE 30 illustrated in FIG. 5 includes one or more line interface units (LIUs) 301 including a memory, a control unit (COM) 302 controlling communication via the LIU 301 or an operation of the NE 30, and a cooling fan (FAN) 303.

A communication cable such as an optical fiber cable or the Ethernet (a registered trademark) is connected to the LIU 301 according to the purpose.

The control unit 302, for example, includes a CPU, a memory, a HDD, and an NIC. As the CPU reads a program or data from the memory or the HDD according to need and performs its operation, the function as the NE 30 is implemented.

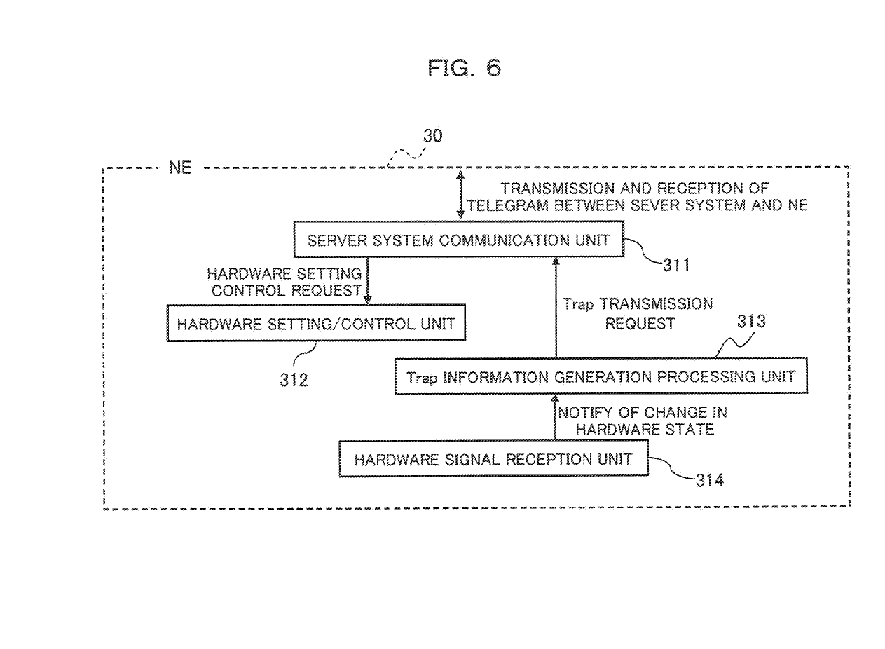

FIG. 6 exemplifies a functional block diagram of the NE 30. For example, the NE 30 illustrated in FIG. 6 includes a server system communication unit 311, a hardware setting/control unit 312, a trap information generation processing unit 313, and a hardware signal reception unit 314.

The hardware setting/control unit 312 transmits control information received from the server system to the hardware setting/control unit 312. Further, the hardware setting/control unit 312 transmits information received from the trap information generation processing unit 313 to the server system.

The hardware setting/control unit 312 performs a hardware setting and hardware control on the LIU 301 or the like.

The trap information generation processing unit 313 generates trap information used to give notification to the server system based on a state change (event) notification received from the hardware signal reception unit 314, and transmits the generated trap information to the server system communication unit 311. The trap information is an example of event information to be transmitted from the corresponding NE 30 when a failure of the NE 30 occurs or when the state change occurs.

(Server System)

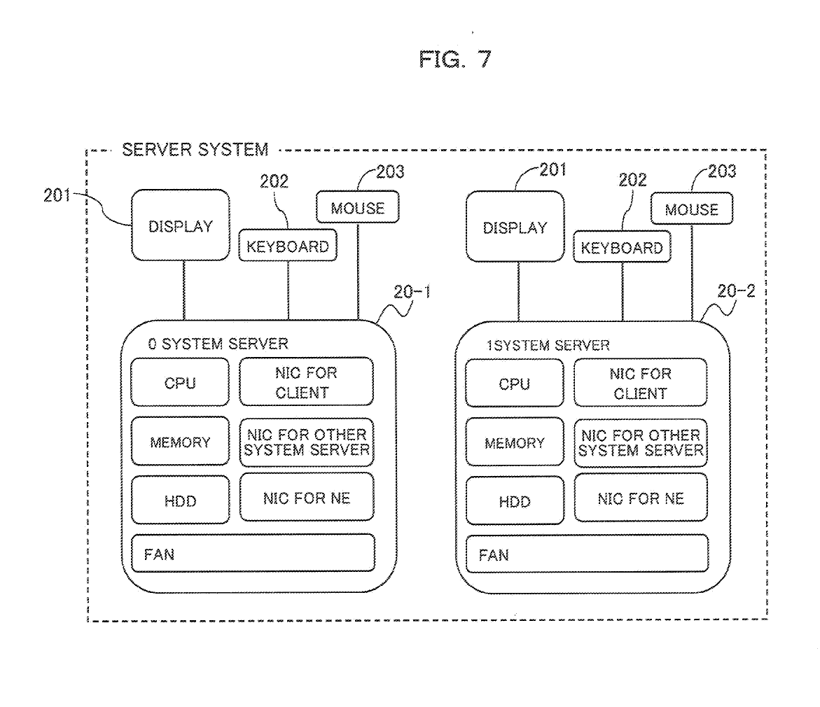

Next, FIG. 7 illustrates an exemplary hardware configuration of the server system. For example, the server system illustrated in FIG. 7 includes two servers, that is, an ACT-system (0-system) server 20-1 and an STBY-system (1-system) server 20-2. Each of the servers 20-1 and 20-2 includes a display (display device) 201 as an example of an output device and a keyboard 202 and a mouse 203 which are an example of an input device.

Further, each of the servers 20-1 and 20-2 (hereinafter, referred to as a “server 20” when the two servers are not distinguished from each other) includes a CPU, a memory, a HDD, an NIC for client, an NIC for the other system server, an NIC for an NE, and a cooling fan. As the CPU reads a program or data from the memory or the HDD according to need and performs its operation, the function as the server 20 is implemented.

The NIC for the client is a communication interface with the client system.

The NIC for the other system server is a communication interface with the server of the other system.

The NIC for the NE is a communication interface with the NE 30.

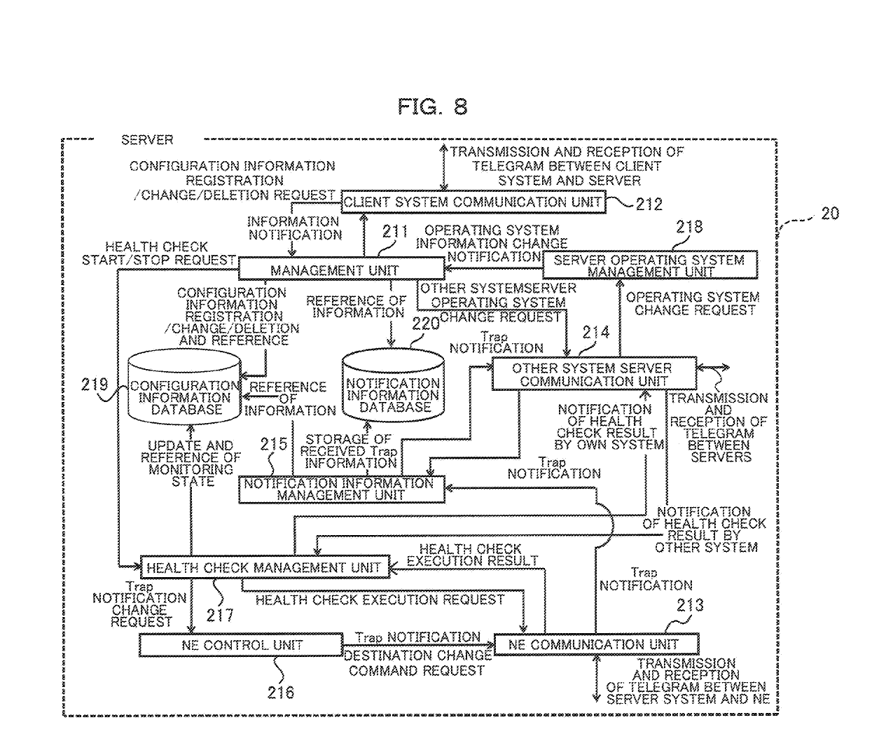

FIG. 8 illustrates a functional block diagram of the server 20. For example, the server 20 illustrated in FIG. 8 includes a management unit 211, a client system communication unit 212, an NE communication unit 213, another system server communication unit 214, a notification information management unit 215, an NE control unit 216, a health check management unit 217, a server operating system management unit 218, a configuration information database 219, and a notification information database 220.

The management unit 211 controls the server 20 in general such as processing of a request received from the client system communication unit 212, activation, and stop. Further, the management unit 211 transmits information to be transmitted to the client system to the client system communication unit 212.

The client system communication unit 212 transmits information received from the client system to the management unit 211. Further, the client system communication unit 212 transmits information received from the management unit 211 to the client system.

The NE communication unit 213 performs command transmission and information acquisition on the NE 30 in response to a control request received from the NE control unit 216 and the health check management unit 217. Further, the NE communication unit 213 transmits trap notification (trap information) received from the NE 30 to the notification information management unit 215.

The other system server communication unit 214 processes information received from the server 20 of the other system. Further, the other system server communication unit 214 transmits information to the server 20 of the other system.

The notification information management unit 215 stores the trap notification received from the NE communication unit 213 in the notification information database 220, and transmits the trap notification to the other system server communication unit 214 in response to conditions.

The NE control unit 216 receives a request for controlling the NE 30, generates a command in response to the request, and transmits the generated command to the NE communication unit 213.

The health check management unit 217 transmits a health check request to the NE communication unit 213 in response to the health check request received from the management unit 211. Further, the health check management unit 217 stores an execution result of the health check received from the NE communication unit 213 in the notification information database 220.

The server operating system management unit 218 manages an operating state and a non-operating state of the server 20.

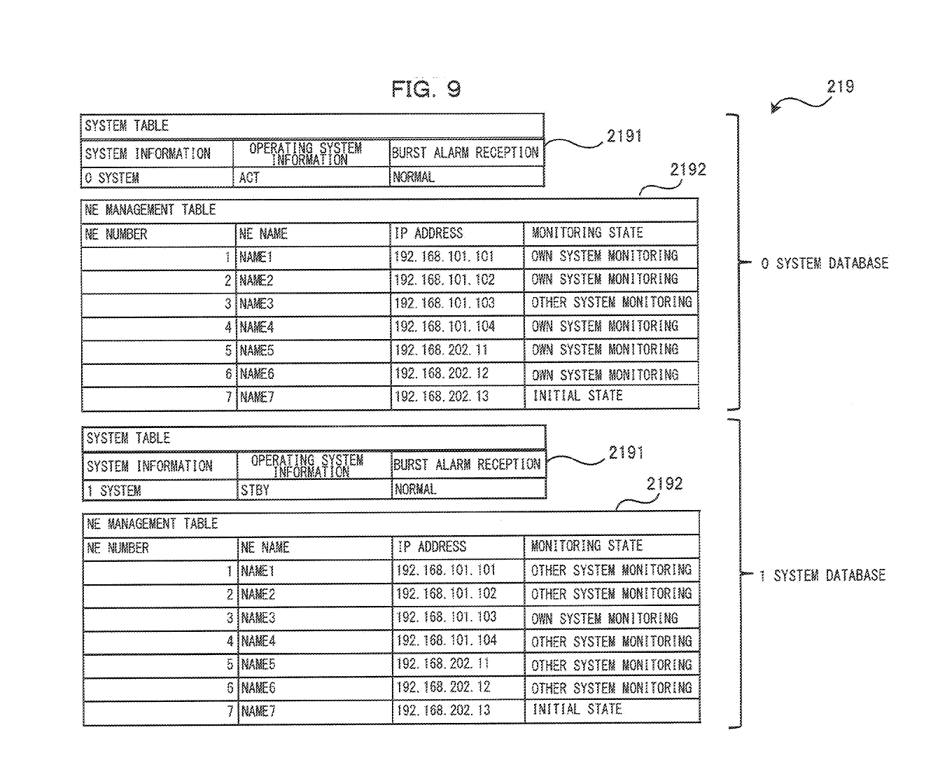

The configuration information database 219 holds information of the NE 30 to be managed or information of a network configured by the NEs 30. FIG. 9 illustrates an example of the configuration information database 219. For example, the configuration information database illustrated in FIG. 9 includes a system table 2191 and an NE management table 2192 for each of the 0 system and the 1 system.

For example, system information, operating system information, burst alarm reception information, or the like can be set to the system table 2191. The system information is information representing whether the system is the 0 system or the 1 system, the operating system information is information representing the ACT or STBY, and the burst alarm reception information is information representing a reception state of a burst alarm.

For example, information such as an NE number, an NE name, an IP address, or a monitoring state can be set to the NE management table 2192.

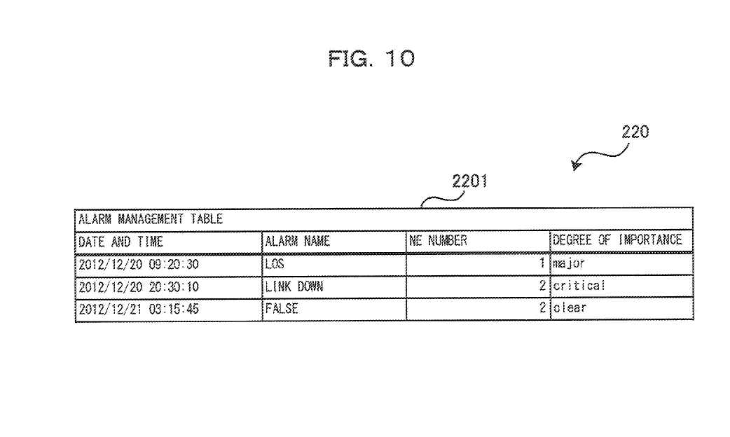

The notification information database 220 stores the trap information received from the NE 30. FIG. 10 illustrates an example of the notification information database 220. For example, the notification information database 220 illustrated in FIG. 10 holds an alarm management table 2201. Information such as an alarm name, an occurrence date and time of an alarm, the NE numbers in which an alarm has occurred, and an importance level of an occurred alarm can be set to the alarm management table 2201.

The configuration information database 219 and the notification information database 220 are stored in the HDD illustrated in FIG. 7, for example.

(Operation Explanation)

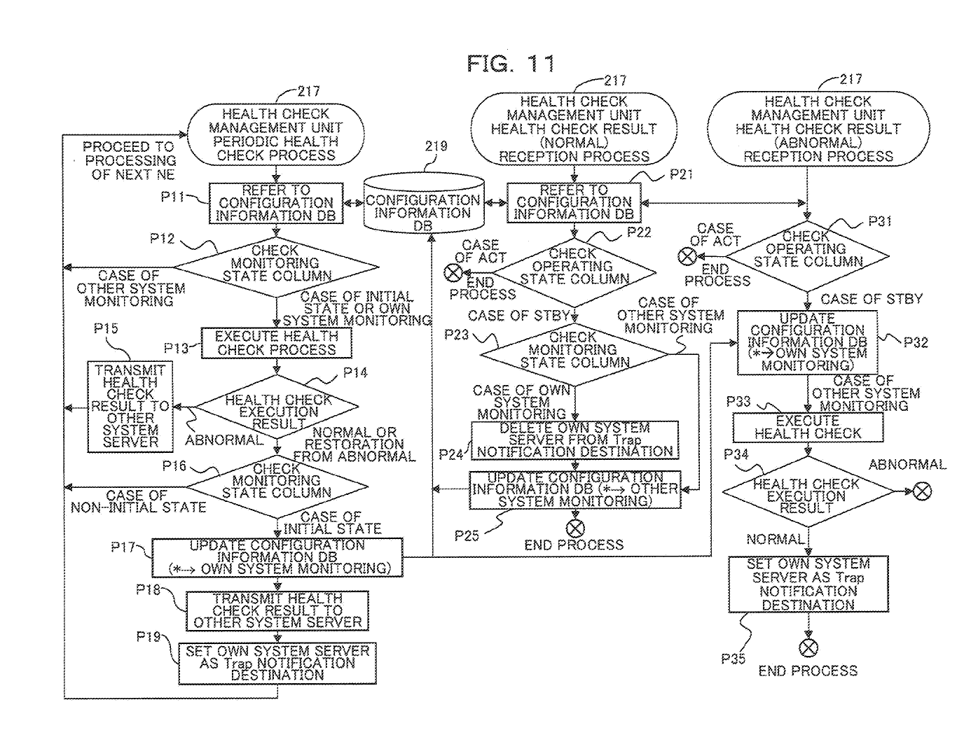

Next, an operation of the NE operating system, described above, will be described with reference to FIGS. 11 to 20.

FIG. 11 is a flowchart illustrating an exemplary operation of the health check management unit 217.

When the NE 30 of the monitoring target is newly added or when the server 20 is activated, the management unit 211 transmits a health check start request to the health check management unit 217 in order to check a communication state of the NE 30.

The health check management unit 217 performs schedule registration for the target NE 30, and then proceeds to a health check execution sequence. In the health check execution sequence, a “monitoring state” column of the target NE in the configuration information database 219 (the NE management table 2192) is referred to (Processes P11 and P12).

The “monitoring state” column of the target NE represents an “initial state” or an “own system monitoring,” the health check management unit 217 transmits a health check execution request to the NE communication unit 213 (Process P13). When the “monitoring state” column of the target NE 30 represents an “other system monitoring,” the health check management unit 217 proceeds to processing of the next NE 30.

Upon receiving the health check execution request from the health check management unit 217, the NE communication unit 213 executes the health check on the target NE 30, and transmits the execution result to the health check management unit 217 (Process P14).

When the execution result of the health check represents “abnormal,” the health check management unit 217 notifies the other system server communication unit 214 of a health check result (Process P15). The other system server communication unit 214 transmits the health check result to the server 20 of the other system.

When the execution result of the health check represents “normal” or “restoration from abnormal”, the health check management unit 217 checks the “monitoring state” column of the target NE 30 in the configuration information database 219 (the NE management table 2192) (Process P16).

When the check result of the “monitoring state” column represents the “initial state,” the health check management unit 217 updates the “monitoring state” column to an “own system monitoring” (Process P17). Further, the health check management unit 217 notifies the other system server communication unit 214 of the health check result (Process P18).

The other system server communication unit 214 transmits the health check result to the server 20 of the other system. Further, the health check management unit 217 sets the server 20 of the own system as the trap notification destination (Process P19).

When the check result of the “monitoring state” column is not the “initial state,” the health check management unit 217 proceeds to processing of the next NE 30.

When the health check result representing “normal” is received from the server 20 of the other system, the health check management unit 217 refers to the system table 2191 of the configuration information database 219 (Process P21), and checks which of “ACT” and “STBY” the “operation state (operating system information)” column represents (Process P22).

When the “operation state (operating system information)” column represents “STBY,” the health check management unit 217 checks whether the “monitoring state” column represents an “own system monitoring” with reference to the NE management table 2192 of the configuration information database 219 (Process P23).

When the “monitoring state” column represents the “own system monitoring,” the health check management unit 217 deletes information of the own system server from information of the trap notification destination (Process P24), and updates the “monitoring state” column of the target NE to an “other system monitoring” (Process P25).

When the “operation state (operating system information)” column represents “ACT” in Process P22, the health check management unit 217 ends the process. Further, when the “monitoring state” column represents an “other system monitoring” in Process P23, the health check management unit 217 maintains the “monitoring state” column of the target NE 30 to represent the “other system monitoring.”

When the health check result representing “abnormal” is received from the server 20 of the other system, the health check management unit 217 checks which of “ACT” and “STBY” the “operation state (operating system information)” column represents with reference to the system table 2191 of the configuration information database 219 (Process P31).

When the “operation state (operating system information)” column represents “STBY,” the health check management unit 217 updates the “monitoring state” column of the target NE 30 in the configuration information database 219 (the NE management table 2192) to an “other system monitoring” (Process P32). Meanwhile, when the “operation state (operating system information)” column represents “ACT,” the health check management unit 217 ends the process.

When the “monitoring state” column of the target NE 30 is updated to the “other system monitoring,” the health check management unit 217 transmits the health check execution request to the NE communication unit 213 (Process P33).

Upon receiving the health check execution request from the health check management unit 217, the NE communication unit 213 executes the health check on the target NE 30, and transmits the execution result to the health check management unit 217.

The health check management unit 217 checks the execution result of the health check (Process P34), and ends the process when the execution result represents an “abnormal.” However, when the execution result of the health check represents a “normal,” the health check management unit 217 sets information of the own system server as information of the trap notification destination (Process P35), and ends the process.

As described above, the collaborative health check can be executed between the servers.

Further, when the “monitoring state” column of the target NE 30 in the configuration information database 219 (the NE management table 2192) is updated to an “own system monitoring” (or a “both system monitoring”), the health check management unit 217 transmits a trap notification destination setting request of the target NE 30 to the NE control unit 216.

Furthermore, when the “monitoring state” column of the target NE 30 is updated to an “other system monitoring,” the health check management unit 217 transmits a trap notification destination release request of the target NE 30 to the NE control unit 216.

Upon receiving the trap notification destination change command (the trap notification destination setting/release request), the NE communication unit 213 transmits the command to the target NE 30.

Through this operation, of the servers 20 of the respective systems, only the server 20 of the system that is executing the health check can receive the trap notification from the NE 30.

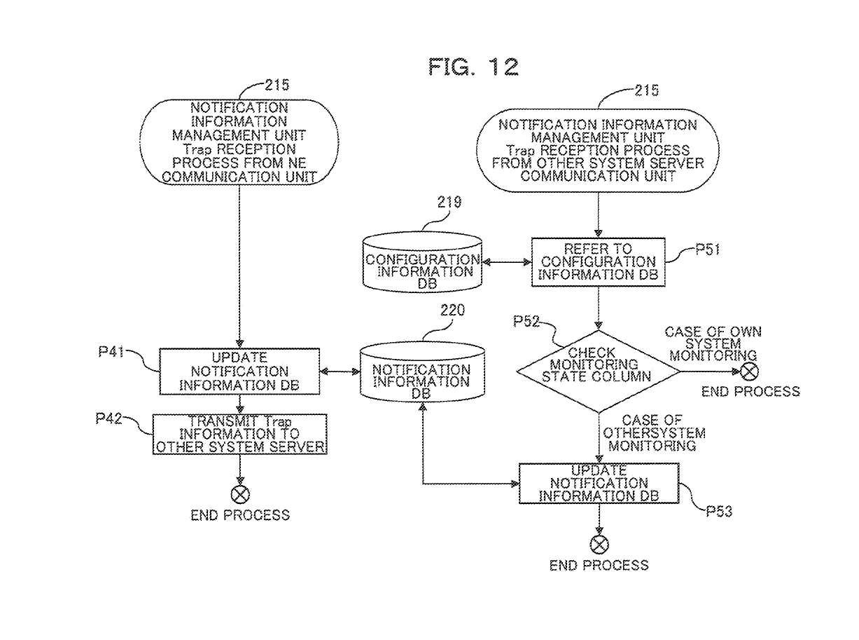

FIG. 12 is a flowchart illustrating an exemplary operation of the notification information management unit 215.

The NE communication unit 213 that has received the trap notification from the NE 30 transmits the trap information to the notification information management unit 215. The notification information management unit 215 stores the trap information in the notification information database (Process P41), and transmits the trap information to the other system server communication unit 214 (Process P42).

Further, when the trap information is received from the other system server communication unit 214, the notification information management unit 215 refers to the “monitoring state” column of the target NE 30 in the configuration information database 219 (the NE management table 2192) (Processes P51 and P52).

When the “monitoring state” column represents the “own system monitoring,” the notification information management unit 215 ends the process. Meanwhile, when the “monitoring state” column represents an “other system monitoring,” the notification information management unit 215 stores the trap information in the notification information database 220 (Process P53).

Notification of the trap information is given to the client system such that the management unit 211 acquires the trap information stored in the notification information database 220, and gives information notification to the client system communication unit 212.

As described above, notification of the trap information received in one system is given to the other system, and thus both of the systems can receive the same trap information.

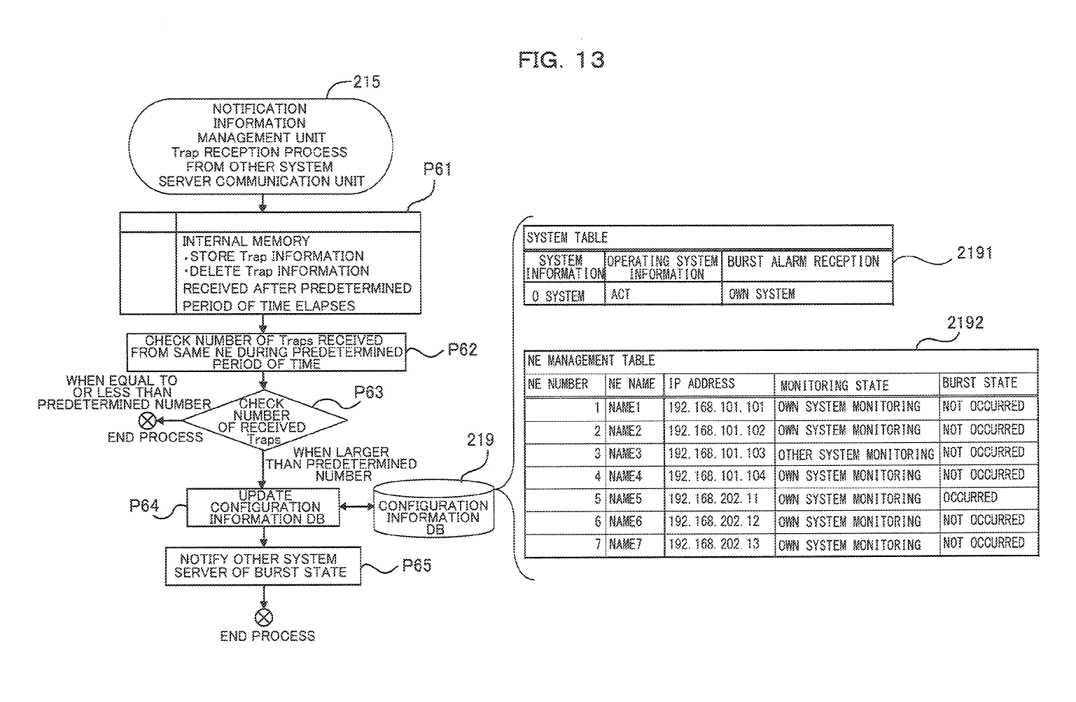

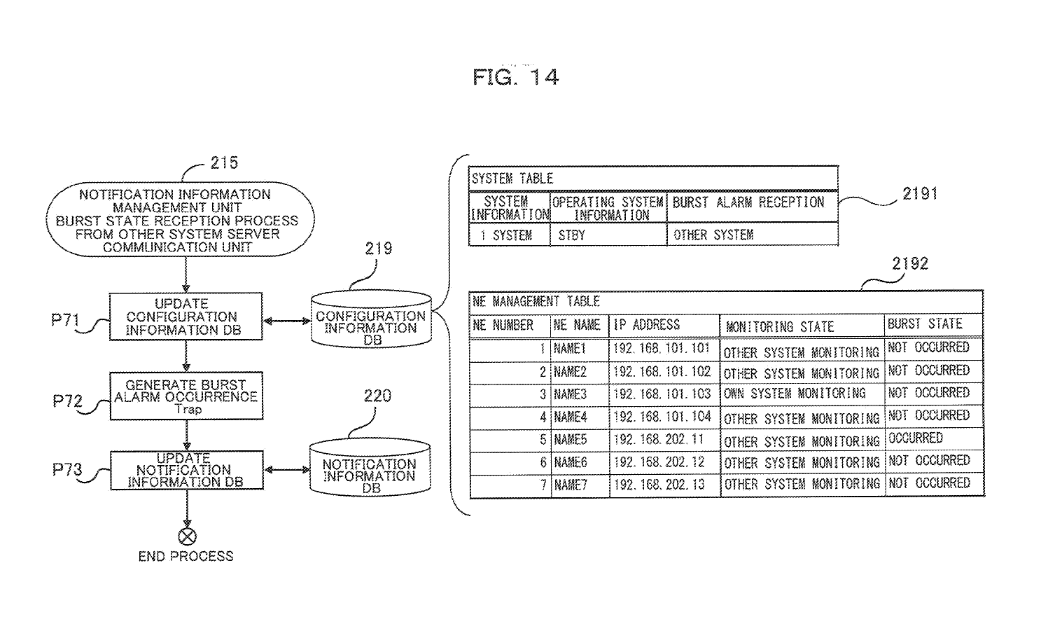

FIGS. 13 and 14 are flowcharts illustrating an exemplary operation of the notification information management unit 215.

As illustrated in FIG. 13, upon receiving the trap information from the NE communication unit 213, the notification information management unit 215 stores the trap information in an internal memory. Further, trap information received after a predetermined period of time elapses may be deleted (Process P61). The notification information management unit 215 checks the number of traps received from the same NE 30 during a predetermined period of time (Process P62), and checks whether the number of received traps has exceeded a predetermined number (Process P63). The predetermined period of time and the predetermined number can be set in a configuration file.

When the number of pieces of trap information received during the predetermined period of time is equal to or less than the predetermined number, the notification information management unit 215 ends the process. When the number of pieces of trap information received within the predetermined period of time is larger than the predetermined number, the notification information management unit 215 determines that a large amount of alarms (burst alarm) have occurred from the target NE 30. When it is determined that the burst alarm has occurred, the notification information management unit 215 updates the “burst state” column of the target NE in the NE management table 2192 of the configuration information database 219 to an “occurred” and updates the “burst alarm reception” column of the system table 2191 to an “own system” (Process P64). Then, the notification information management unit 215 notifies the other system server communication unit 214 of the burst state of the target NE 30 (Process P65).

Meanwhile, as illustrated in FIG. 14, when notification of the burst state is given to the other system server communication unit 214 of the server 20 of the other system, the notification information management unit 215 updates the “burst state” column of the target NE in the configuration information database 219 (the NE management table 2192) to an “occurred.” Further, the notification information management unit 215 updates the “burst alarm reception” column of the system table 2191 to an “other system.” (Process P71).

Further, the notification information management unit 215 generates a burst alarm occurrence trap (Process P72), and stores the generated burst alarm occurrence trap in the notification information database 220 (Process P73). Through this operation, it is possible to notify the client system of the fact that the burst alarm is occurring.

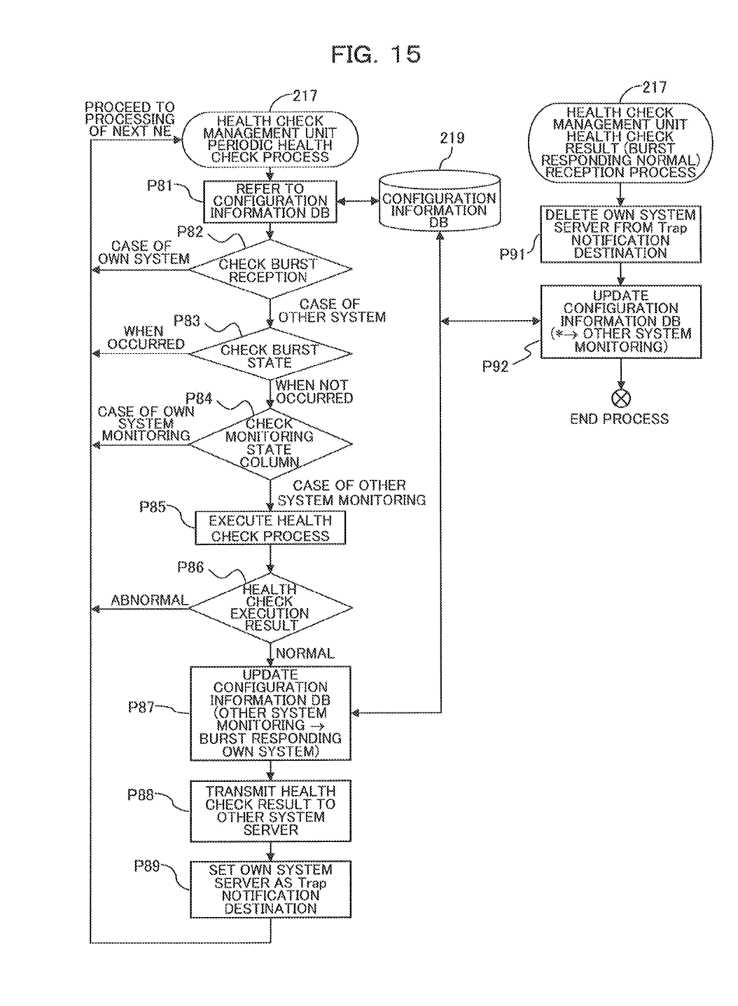

As illustrated in FIG. 15, in the health check execution sequence by the health check management unit 217, the “burst alarm reception” column, the “burst state” column, and the “monitoring state” column are checked (Processes P82 to P84) with reference to the configuration information database 219 (Process P81).

When the “burst alarm reception” column of the configuration information database 219 represents an “other system,” the “burst state” column of the target NE 30 does not represents an “occurred,” and the “monitoring state” column represents an “other system monitoring,” the health check management unit 217 transmits the health check execution request to the NE communication unit 213 (Process P85).

The NE communication unit 213 executes the health check on the target NE 30, and transmits the execution result to the health check management unit 217. The health check management unit 217 checks whether the health check result represents a “normal” or an “abnormal” (Process P86).

When the health check result represents the “normal,” the health check management unit 217 updates the “monitoring state” column of the target NE 30 in the configuration information database 219 to a “burst responding own system” (Process P87), and transmits the health check result to the other system server communication unit 214 (Process P88). Further, the health check management unit 217 sets information of the own system server as information of the trap notification destination (Process P89).

When the “burst alarm reception” column does not represents an “other system,” when the “burst state” column of the target NE represents an “occurred,” or when the “monitoring state” column represents an “own system monitoring,” the health check management unit 217 proceeds to processing of the next NE 30.

Upon receiving the health check result from the server 20 of the other system, the health check management unit 217 of the server 20 of the own system deletes information of the own system server from information of the trap notification destination (Process P91), and updates the “monitoring state” column of the target NE 30 of the configuration information database 219 to an “other system monitoring” (Process P92).

The health check management unit 217 executes the health check when the “monitoring state” column of the target NE 30 in the configuration information database 219 represents an “initial state,” an “own system monitoring,” and a “burst responding own system.”

Through the operation above, when the burst alarm is received from the same NE 30, it is possible to switch the server 20 that executes the health check on the NE 30 other than the corresponding NE 30 to the STBY system.

Further, the “monitoring state” column of the target NE 30 in the configuration information database 219 is updated to a “burst responding own system” or a “burst responding other system,” the health check management unit 217 transmits the trap notification destination setting request of the target NE 30 to the NE control unit 216.

Further, when the “monitoring state” column of the target NE 30 is updated to an “other systems monitoring,” the health check management unit 217 transmits the trap notification destination release request of the target NE 30 to the NE control unit 216.

Upon receiving the trap notification destination change command (the trap notification destination setting/release request) from the NE control unit 216, the NE communication unit 213 transmits the command to the target NE 30.

Through the operation above, it is possible to change the trap notification destination of the target NE when the server 20 executing the health check is switched.

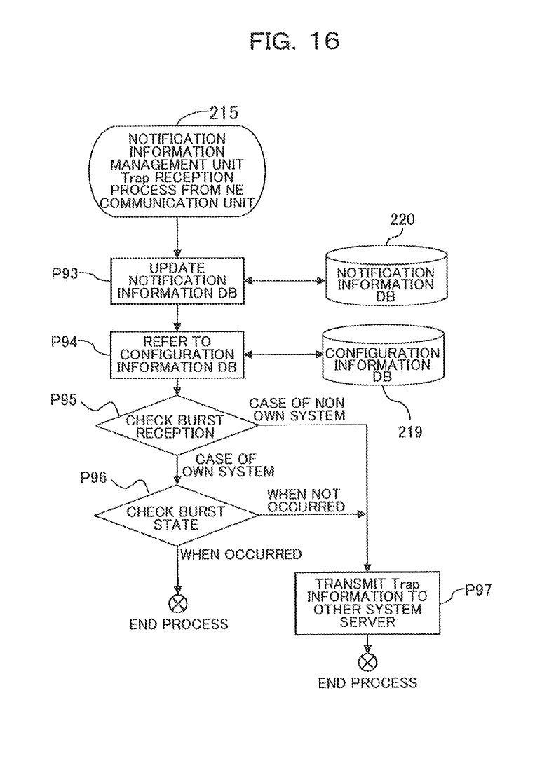

FIG. 16 is a flowchart illustrating an exemplary operation of the notification information management unit 215.

The notification information management unit 215 checks the “burst alarm reception” column and the “burst state” column (Processes P95 and P96) with reference to the notification information database 220 and the configuration information database 219 (Processes P93 and P94).

When the “burst alarm reception” column does not represents an “own system” and when trap information is received from an NE 30 represented as “not occurred” in the “burst state” column, the notification information management unit 215 transmits the trap information to the other system server communication unit 214 (Process P97).

Meanwhile, when the “burst alarm reception” column represents an “own system” and when trap information is received from an NE 30 represented as “occurred” in the “burst state” column, the notification information management unit 215 ends the process without transmitting the trap information to the other system server communication unit 214.

Through the operation above, it is possible to prevent the server 20 from notifying the other server 20 of trap information received from the NE 30 in which the burst alarm is occurring.

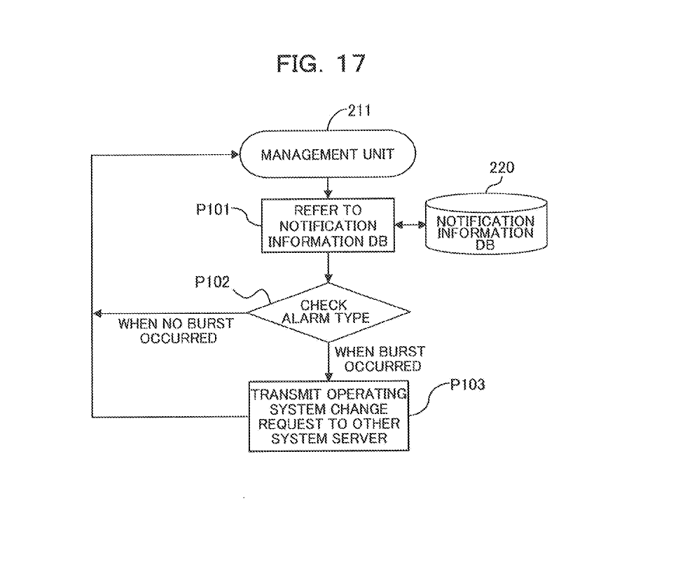

Next, FIG. 17 is a flowchart illustrating an exemplary operation of the management unit 211.

The management unit 211 checks an alarm type with reference to the notification information database 220 (Processes P101 and P102). As a result of checking, when information representing “burst alarm occurred” is acquired, the management unit 211 transmits an operating system change request to the other system server communication unit 214 (Process P103).

The other system server communication unit 214 transmits the operating system change request to the server operating system management unit 218, and transmits a request to change to the non-operating system to the server 20 of the other system.

Through the operation above, it is possible to switch a system which is monitoring an NE 30 other than the NE 30 in which the burst alarm is occurring to the ACT system.

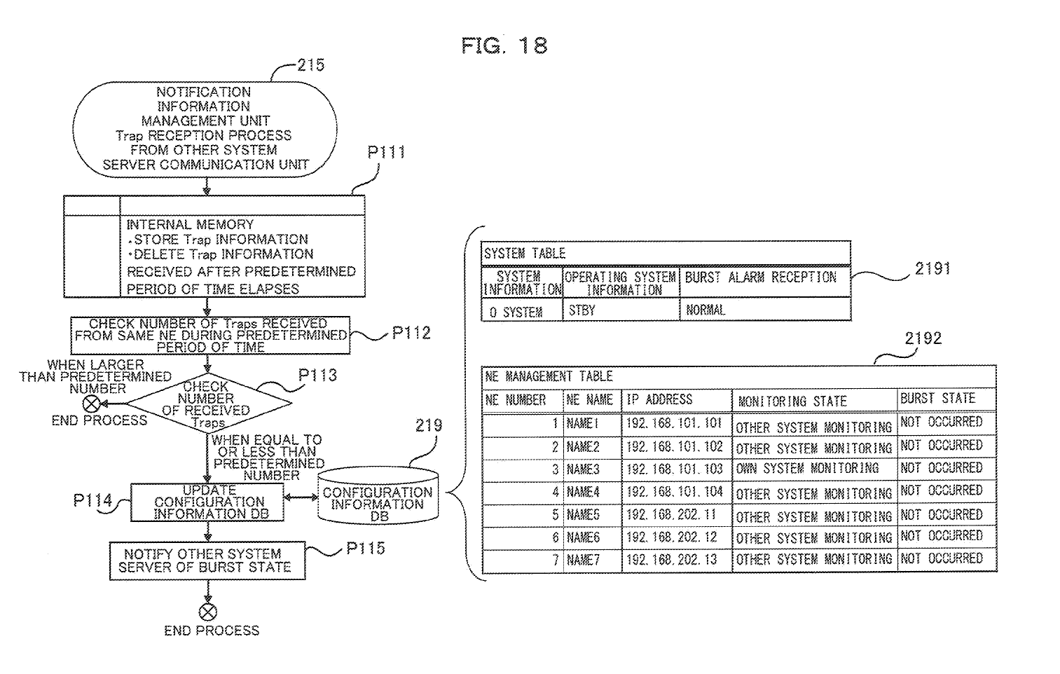

FIG. 18 is a flowchart illustrating an exemplary operation of the notification information management unit 215.

Upon receiving trap information from the NE communication unit 213, the notification information management unit 215 stores the trap information in an internal memory. Trap information received after a predetermined period of time elapses may be deleted (Process P111). The notification information management unit 215 checks the number of traps received from the same NE 30 during the predetermined period of time (Process P112), and checks whether the number of received traps is equal to or less than a predetermined number (Process P113). The predetermined period of time and predetermined number can be set in the configuration file.

When the number of pieces of trap information received during the predetermined period of time is larger than the predetermined number, the notification information management unit 215 ends the process. When the number of pieces of trap information received during the predetermined period of time is equal to or less than the predetermined number, the notification information management unit 215 determines that a large amount of alarms (burst alarm) occurred in the target NE 30 has been recovered. When it is determined that the burst alarm has been recovered, the notification information management unit 215 updates the “burst state” column of the target NE 30 in the NE management table 2192 of the configuration information database 219 to “not occurred,” and updates the “burst alarm reception” column of the system table 2191 to a “normal” (Process P114). Then, the notification information management unit 215 notifies the other system server communication unit 214 of the burst state (recovery) of the target NE 30 (Process P115).

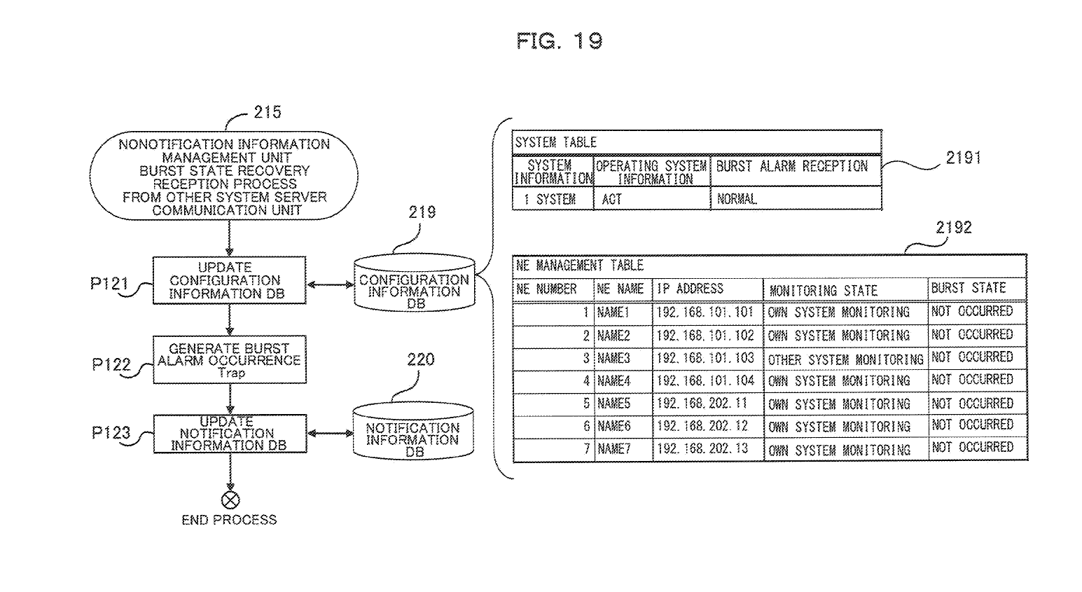

Meanwhile, as illustrated in FIG. 19, when the other system server communication unit 214 of the server 20 of the other system is notified of the recovery of the burst state, the notification information management unit 215 updates the “burst state” column of the target NE 30 in the configuration information database 219 (the NE management table 2192) to “not occurred.” Further, the notification information management unit 215 updates the “burst alarm reception” column of the system table 2191 to a “normal” (Process P121).

Further, the notification information management unit 215 generates a burst alarm recovery trap (Process P122), and stores the generated burst alarm recovery trap in the notification information database 220 (Process P123). Through this operation, it is possible to notify the client device 10 of the recovery of the burst alarm.

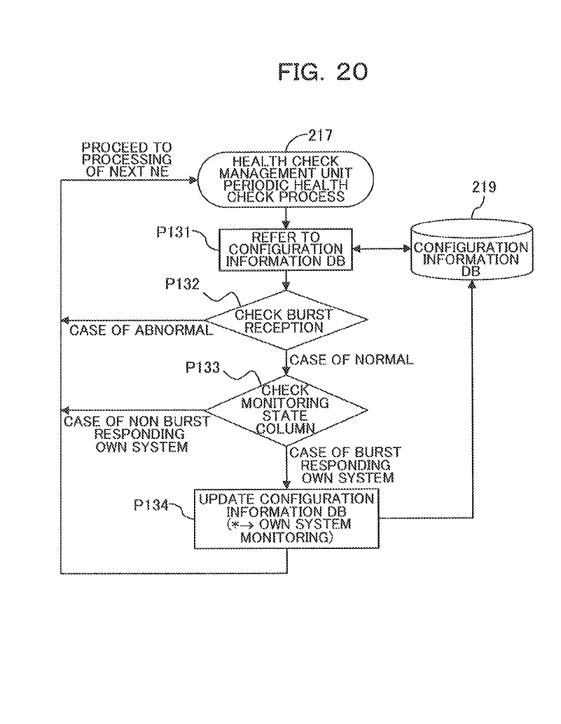

Next, FIG. 20 is a flowchart illustrating an exemplary operation of the health check management unit 217.

In the health check execution sequence by the health check management unit 217, with reference to the configuration information database 219 (Process P131), it is checked whether the “burst alarm reception” column represents a “normal,” and it is checked whether the “monitoring state” column of the target NE 30 represents a “burst responding own system” (Process P132 and P133).

When the “burst alarm reception” represents the “normal” and the “monitoring state” column of the target NE 30 represents the “burst responding own system,” the “monitoring state” column is updated to an “own system monitoring” (Process P134). In any other case, the health check management unit 217 proceeds to processing of the next NE 30.

With respect to the NE 30 for which the “burst state” column of the configuration information database 219 has been updated to “not occurred,” the “monitoring state” column is updated to an “own system monitoring,” and the trap notification destination setting request of the corresponding NE 30 is transmitted to the NE control unit 216. Upon receiving the trap notification destination change command from the NE control unit 216, the NE communication unit 213 transmits the command to the corresponding NE 30.

Through the operation above, normal monitoring can be automatically returned when the burst alarm is recovered.

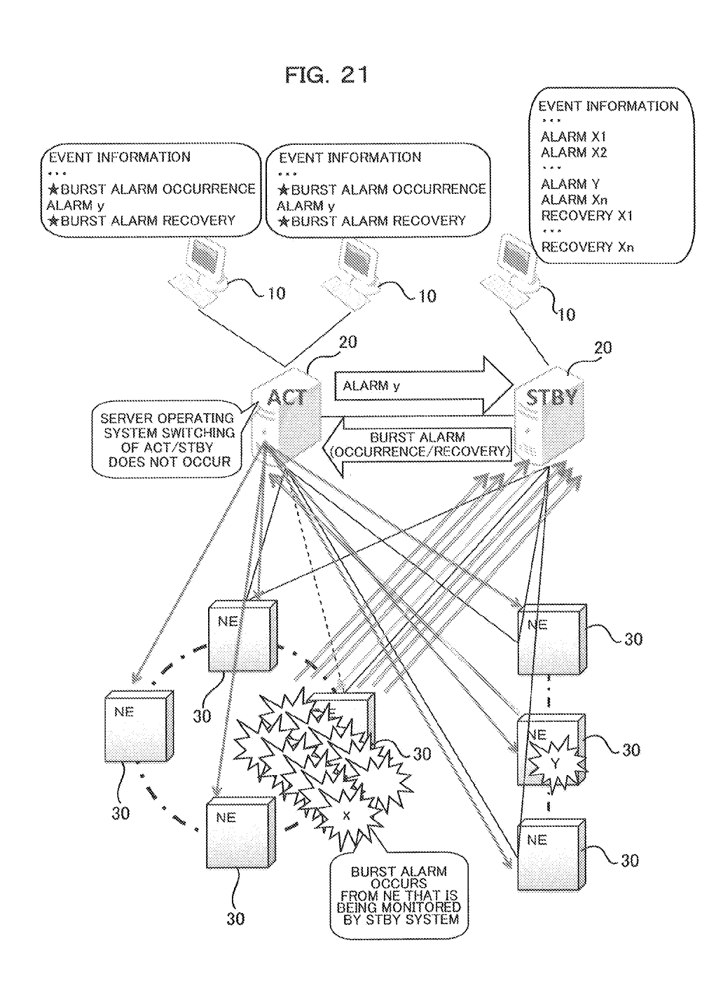

As illustrated in FIG. 21, when the server 20 of the STBY system receives a burst alarm, notification of information representing that the burst alarm is occurring is given, instead of transmitting trap information received from the NE 30 in which burst alarm is occurring, to the server 20 of the other system. At this time, the ACT/STBY operating system of the server 20 does not change.

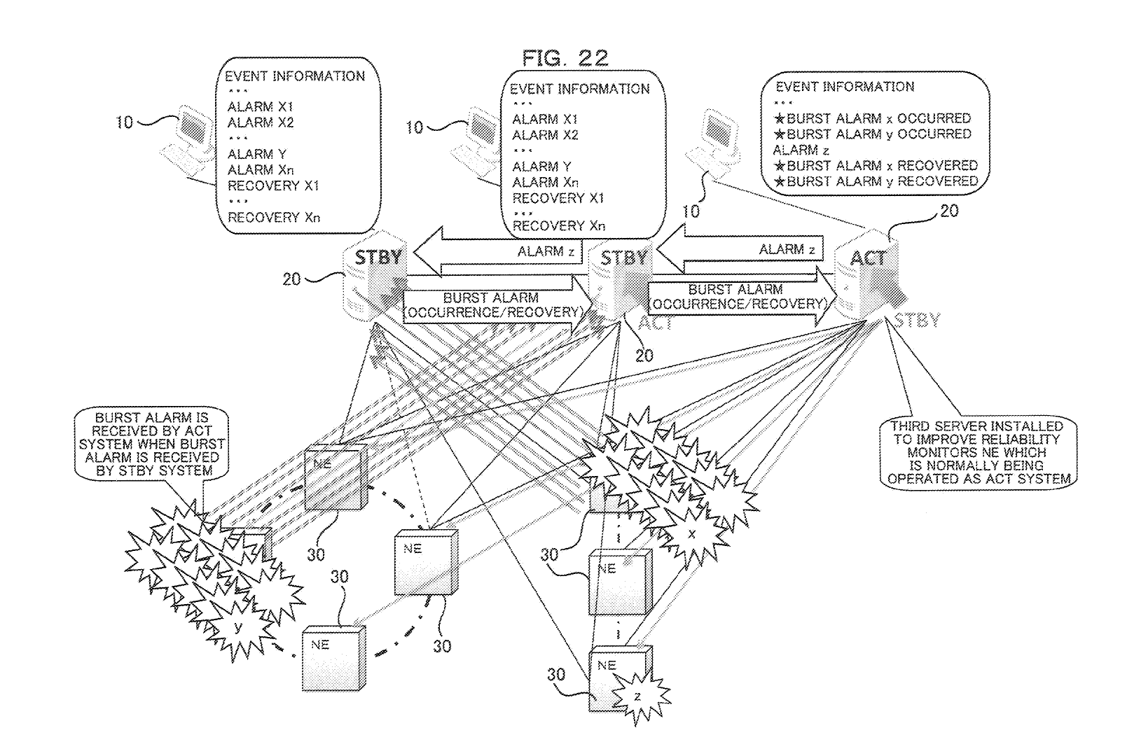

Further, as illustrated in FIG. 22, in a configuration in which there are a plurality of servers 20 of the STBY system, there are cases in which one server 20 of the STBY system receives a burst alarm, and the server 20 of the ACT system also receives a burst alarm. In this case, at least one server 20 among the rest of the servers 20 in the STBY system is switched to a server 20 of the ACT system, and monitors the NE 30 under being operated normally.

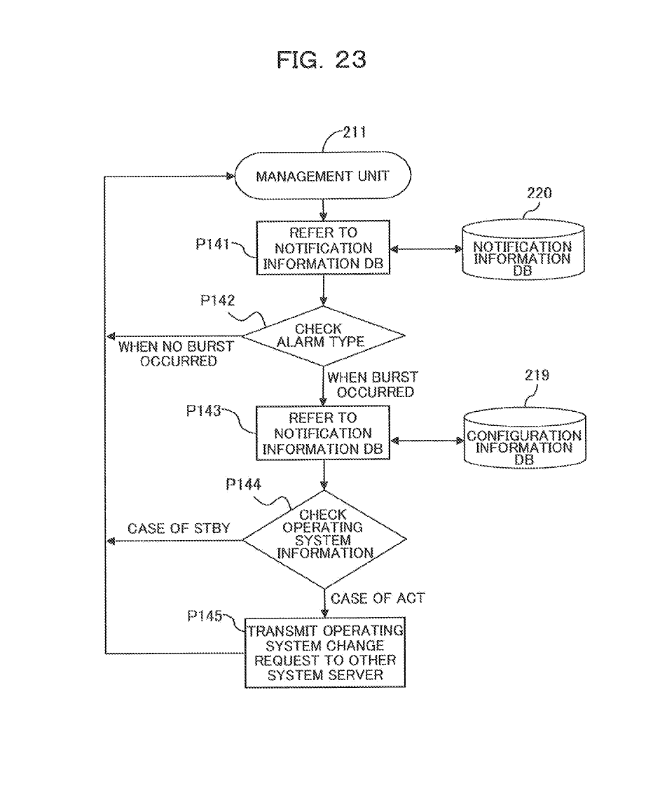

Here, the server 20 of the ACT system and the server 20 of the STBY system is the same in processing of the notification information management unit 215 and the health check management unit 217 when the burst alarm is received. FIG. 23 illustrates an exemplary operation of the management unit 211.

As illustrated in FIG. 23, the management unit 211 checks the alarm type with reference to the notification information database 220 (Processes P141 and P142). As a result of checking, upon obtaining information representing a “burst alarm occurred,”, the management unit 211 refers to and checks the “operating system information” column of the configuration information database 219 (Processes P143 and P144).

When the “operating system information” column represents an “ACT,” the management unit 211 transmits the operating system change request to the other system server communication unit 214 (Process P145). Meanwhile, when the alarm type represents “no burst occurred” or when the “operating system information” column represents a “STBY,” the management unit 211 does not transmit the operating system change request to the other system server communication unit 214.

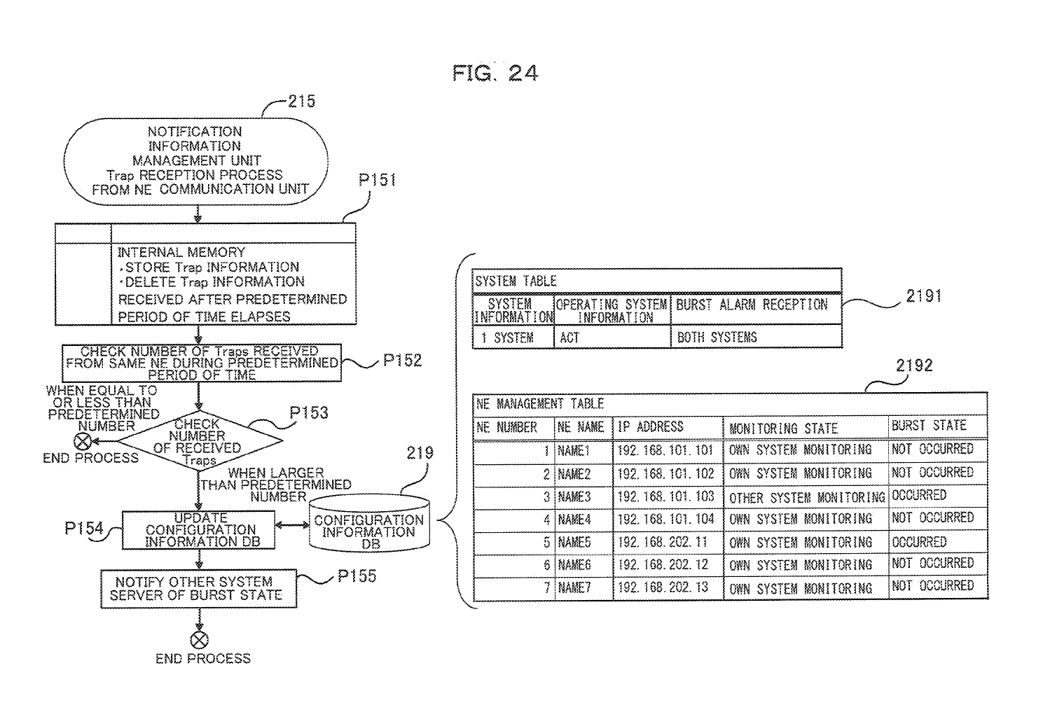

Further, as illustrated in FIG. 24, upon receiving trap information from the NE communication unit 213, the notification information management unit 215 stores the received trap information in an internal memory. Trap information received after a predetermined period of time elapses may be deleted (Process P151). The notification information management unit 215 checks the number of traps received from the same NE 30 during the predetermined period of time (Process P152), and checks whether the number of received traps is larger than a predetermined number (Process P153). The predetermined period of time and the predetermined number can be set in the configuration file.

When the number of pieces of trap information received during the predetermined period of time is equal to or less than the predetermined number, the notification information management unit 215 ends the process. When the number of pieces of trap information received during the predetermined period of time is larger than the predetermined number, the notification information management unit 215 determines that a large amount of alarms (burst alarm) have occurred from the objective NE 30. When it is determined that the burst alarm has occurred, the notification information management unit 215 updates the “burst state” column of the objective NE 30 in the NE management table 2192 of the configuration information database 219 to “occurred.”

At this time, when the “burst alarm reception” column represents an “other system,” since the burst alarm is received by both systems, the notification information management unit 215 updates the “burst alarm reception” column in the system table 2191 of the configuration information database 219 to a “both systems” (Process P154). Then, the notification information management unit 215 notifies the other system server communication unit 214 of the burst state of the objective NE 30 (Process P155). Through this operation, it is possible to notify a third server 20 of the burst state of the objective NE 30.

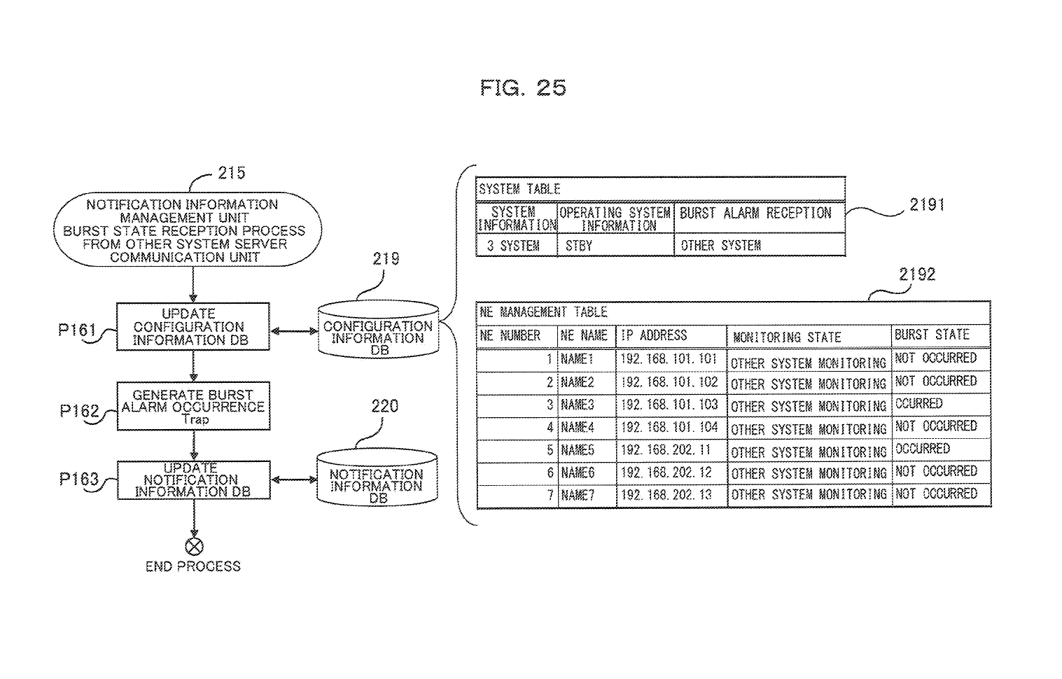

Meanwhile, as illustrated in FIG. 25, when notification of the burst state is given to the other system server communication unit 214 of the server 20 of the other system, the notification information management unit 215 updates the “burst state” column of the objective NE 30 in the configuration information database 219 (the NE management table 2192) to “occurred.” Further, the notification information management unit 215 updates the “burst alarm reception” column of the system table 2191 to an “other system” (Process P161).

Furthermore, the notification information management unit 215 generates the burst alarm occurrence trap (Process P162), and stores the generated burst alarm occurrence trap in the notification information database 220 (Process P163). Through this operation, it is possible to notify the client device 10 of the occurrence of the burst alarm.

According to the embodiment described above, it is possible to reduce a processing load of a server monitoring an NE.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A network element monitoring system, comprising:
a first server and a second server configured to perform health check on a plurality of network elements (NEs) and to monitor operation states of the NEs,
wherein the first server changes an execution source of the health check to the second server in response to a reception state of event information from an NE of a monitoring target.

2. The network element monitoring system according to claim 1,
wherein the first server transmits an execution request of the health check on a second NE other than a first NE which is a transmission source of the event information to the second server, when the first server is in a burst reception state in which the number of pieces of received event information exceeds a threshold value during a certain period of time.

3. The network element monitoring system according to claim 2,
wherein the first server changes a transmission destination of the event information by the second NE to the second server.

4. The network element monitoring system according to claim 3,
wherein the second server notifies the first server of the event information received from the second NE.

5. The network element monitoring system according to claim 3,
wherein the first server does not notify the second server of the event information received from the first NE.

6. The network element monitoring system according to claim 2, further comprising,
a client apparatus communicatively connected to the first and second servers,
wherein one of the first and second servers notifies the client apparatus of the burst reception state.

7. The network element monitoring system according to claim 2,
wherein the first server returns the execution source of the health check to the first server, when the first server is in a burst recovery state in which the number of pieces of received event information is equal to or less than a threshold value during a certain period of time.

8. The network element monitoring system according to claim 7, further comprising,
a client apparatus communicatively connected to the first and second servers,
wherein any one of the first and second servers notifies the client apparatus of the burst recovery state.

9. The network element monitoring system according to claim 1,
wherein the second server notifies the first server of a burst reception state without notifying the first server of the event information, when the second server is in the burst reception state in which the number of pieces of event information received from an NE of a monitoring target exceeds a threshold value during a certain period of time.

10. The network element monitoring system according to claim 1,
wherein both of the first and second servers transmit an execution request of the health check on a second NE other than a first NE which is a transmission source of the event information to a third server, when both of the first and second servers is in a burst reception state in which the number of pieces of event information received from an NE of a monitoring target exceeds a threshold value during a certain period of time.

11. A server configured to: perform health check on a plurality of network elements (NEs) so as to monitor operation states of the NEs; and change an execution source of the health check to another server in response to a reception state of event information from an NE of a monitoring target.

12. A server configured to: perform health check on a plurality of network elements (NEs) so as to monitor operation states of the NEs; and perform health check on an NE which is a monitoring target of another server upon receiving an execution request of the health check on the NE of the monitoring target from the other server, wherein the execution request is transmitted in response to a reception state in the other server which receives event information transmitted from the NE of the monitoring target of the other server.
